(19) United States
(12) Patent Application Publication
(10) Pub. No.: US 2025/0219695 A1
(43) Pub. Date: Jul. 3, 2025

(54) METHODS AND APPARATUS OF CSI OMISSION FOR COHERENT JOINT TRANSMISSION

(71) Applicant: LENOVO (BEIJING) LIMITED, Beijing (CN)

(72) Inventors: Yi ZHANG, Beijing (CN); Chenxi ZHU, Fairfax, VA (US); Wei LING, Beijing (CN); Bingchao LIU, Beijing (CN); Lingling XIAO, Beijing (CN)

(21) Appl. No.: 18/848,345

(22) PCT Filed: Jul. 29, 2022
(86) PCT No.: PCT/CN2022/108925

§ 371 Date: Sep. 18, 2024

(51) Int. Cl. H04B 7/06; H04W 24/10

(52) U.S. Cl. CPC H04B 7/0626; H04W 24/10

(57) ABSTRACT

Methods and apparatus of CSI omission for coherent joint transmission are disclosed. The apparatus includes a receiver that receives a configuration signalling for one or more Channel State Information (CSI) reports for coherent joint transmission (CJT) with a plurality of transmitting-receiving identities; a processor that determines a portion of the CSI reports that is to be omitted in transmission based on a CSI omission scheme; and a transmitter that transmits the CSI reports with the portion being omitted.

### FIELD

The subject matter disclosed herein relates generally to wireless communication and more particularly relates to, but not limited to, methods and apparatus of Channel State Information (CSI) omission for coherent joint transmission (CJT).

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX, or Rx), Transmit or Transmitter (TX, or Tx), Hybrid Automatic Repeat Request (HARQ), Acknowledgement (ACK), Hybrid Automatic Repeat Request Acknowledgement (HARQ-ACK), Physical Uplink Control Channel (PUCCH), Physical Uplink Shared Channel (PUSCH), Shared Channel (SCH), Uplink Shared Channel (UL-SCH), Configured Grant (CG), Channel State Information (CSI), Channel State Information Reference Signal (CSI-RS), Frequency Division Duplex (FDD), Frequency Division Multiple Access (FDMA), Index/Identifier (ID), Multiple Input Multiple Output (MIMO), Reference Signal (RS), Reference Signal Received Power (RSRP), Signal-to-Interference-Plus-Noise Ratio (SINR), Time-Division Duplexing (TDD), Transmission Reception Point (TRP), Uplink Control Information (UCI), Frequency Range 1 (FR1), Frequency Range 2 (FR2), Layer 1 Reference Signal Received Power (L1-RSRP), Precoder Matrix Indicator (PMI), Technical Specification (TS), Layer 1/physical layer (L1), Universal Terrestrial Radio Access Network (UTRAN), Layer 1 Signal to Interference plus Noise Ratio (L1-SINR), Full Duplex (FD), Coherent Joint Transmission (CJT), Joint Transmission (JT), Non-Coherent Joint Transmission (NC-JT).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmission Reception Points) are studied. A TRP is an apparatus to transmit and receive signals, and is controlled by a gNB through the backhaul between the gNB and the TRP.

In Release 18 of 3GPP specifications, enhancements on both downlink and uplink MIMO that facilitate the use of large antenna array, for both FR1 and FR2, are needed to fulfil the demand for evolution of NR deployments.

As coherent joint transmission (CJT) improves coverage and average throughput in commercial deployments with high-performance backhaul and synchronization, enhancement on CSI acquisition for FDD and TDD, targeting FR1, may be beneficial in expanding the utility of multi-TRP deployments.

### SUMMARY

Methods and apparatus of CSI omission for coherent joint transmission are disclosed.

According to a first aspect, there is provided an apparatus, including: a receiver that receives a configuration signalling for one or more Channel State Information (CSI) reports for coherent joint transmission (CJT) with a plurality of transmitting-receiving identities; a processor that determines a portion of the CSI reports that is to be omitted in transmission based on a CSI omission scheme; and a transmitter that transmits the CSI reports with the portion being omitted.

According to a second aspect, there is provided an apparatus, including: a transmitter that transmits a configuration signalling for one or more Channel State Information (CSI) reports for coherent joint transmission (CJT) with a plurality of transmitting-receiving identities; a processor that determines a portion of the CSI reports that is to be omitted in transmission based on a CSI omission scheme; and a receiver that receives the CSI reports with the portion being omitted.

According to a third aspect, there is provided a method, including: receiving, by a receiver, a configuration signalling for one or more Channel State Information (CSI) reports for coherent joint transmission (CJT) with a plurality of transmitting-receiving identities; determining, by a processor, a portion of the CSI reports that is to be omitted in transmission based on a CSI omission scheme; and transmitting, by a transmitter, the CSI reports with the portion being omitted.

According to a fourth aspect, there is provided a method, including: transmitting, by a transmitter, a configuration signalling for one or more Channel State Information (CSI) reports for coherent joint transmission (CJT) with a plurality of transmitting-receiving identities; determining, by a processor, a portion of the CSI reports that is to be omitted in transmission based on a CSI omission scheme; and receiving, by a receiver, the CSI reports with the portion being omitted.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4 is a schematic diagram illustrating an example of updated procedure for CSI omission in the case of CSI reporting including CSI for CJT in accordance with some implementations of the present disclosure.

FIG. 5 is a flow chart illustrating steps of CSI omission for coherent joint transmission by UE in accordance with some implementations of the present disclosure; and

FIG. 6 is a flow chart illustrating steps of CSI omission for coherent joint transmission by gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

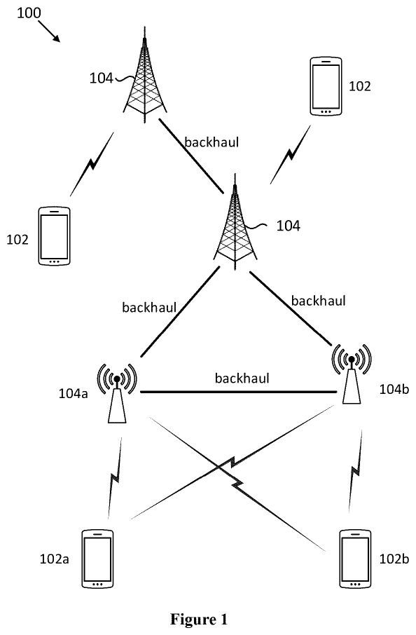

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP”, “Transmission Reception Point”, and “transmitting-receiving identity” may be used interchangeably throughout the disclosure.

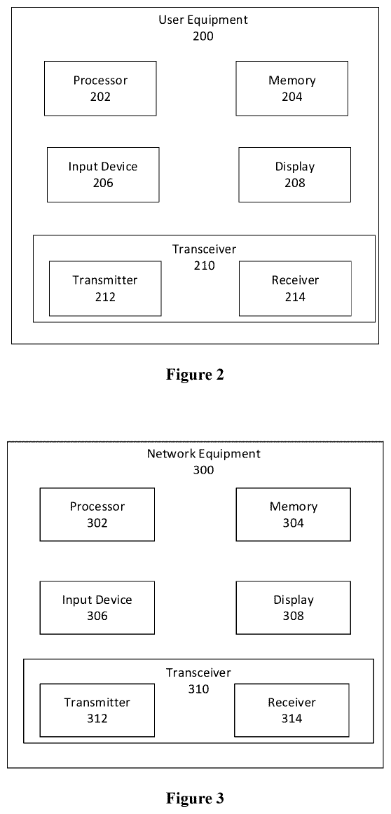

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

It is important to identify and specify necessary enhancements for both downlink and uplink MIMO for facilitating the use of large antenna array, not only for FR1 but also for FR2, to fulfil the request for evolution of NR deployments in Release 18. In Release 16 or 17, features for facilitating multi-TRP deployments have been introduced focusing on non-coherent joint transmission (NC-JT). As coherent joint transmission (CJT) improves coverage and average throughput in commercial deployments with high-performance backhaul and synchronization, enhancement on CSI acquisition for FDD and TDD, targeting FR1, may be beneficial in expanding the utility of multi-TRP deployments.

In Release 18, with coherent joint transmission, same information may be transmitted coherently from multiple TRPs. For CSI reports for CJT, the overhead is larger since UE needs to report CSI for serving cell and cooperative cells. A CSI report on PUSCH comprises two parts, where Part 1 has a fixed payload size and is used to identify the number of information bits in Part 2. The UE may omit a portion of the Part 2 CSI when uplink channel quality is not good enough to carry all the bits of CSI reports. In this disclosure, multiple CSI omission schemes are discussed for CJT based on different definitions of priority levels (which may also be referred to as priority reporting levels) or different partitions based on bit priority definition for group 1 or 2 bits of multiple TRPs' CSI. Further, the final priority level with omission is optimized when CSI report for CJT is included in CSI reports for PUSCH transmission.

In conventional CSI omission scheme, Part 2 CSI is omitted level by level according to the priority order, beginning with the lowest priority level until the priority level at which the requirement of no larger than configured scaling spectrum efficiency is reached. The conventional CSI omission scheme is defined for CSI report for single TRP transmission; and it does not take CSI report for CJT in consideration. The detailed information is provided in 3GPP Technical Specification TS 38.214 as follows:

### CSI Reporting on PUSCH

When CSI reporting on PUSCH comprises two parts, the UE may omit a portion of the Part 2 CSI. Omission of Part 2 CSI is according to the priority order shown in Table 5.2.3-1, where N_{Rep} is the number of CSI reports configured to be carried on the PUSCH. Priority 0 is the highest priority and priority 2N_{Rep} is the lowest priority and the CSI report n corresponds to the CSI report with the nth smallest Pri_{iCSI}(y,k,c,s) value among the N_{Rep} CSI reports as defined in Clause 5.2.5. The subbands for a given CSI report n indicated by the higher layer parameter csi-ReportingBand are numbered continuously in increasing order with the lowest subband of csi-ReportingBand as subband 0. When omitting Part 2 CSI information for a particular priority level, the UE shall omit all of the information at that priority level.
For Enhanced Type II reports, for a given CSI report n, each reported element of indices i_{2,4,l} i_{2,5,l} and i_{1,7,l}, indexed by l, i and f, is associated with a priority value Pri(l,i,f)=2·L·υ·π(f)+υ·i+l, with π(f)=min(2·n_{3,l}^{(f)}, 2·(N₃−n_{3,l}^{(f)})−1) with l=1, 2, . . . , υ, i=0, 1, . . . , 2L−1, and f=0, 1, . . . , M_{υ}−1, and where n_{3,l}^{(f)} is defined in Clause 5.2.2.2.5. The element with the highest priority has the lowest associated value Pri(l,i,f). Omission of Part 2 CSI is according to the priority order shown in Table 5.2.3-1, where
   Group 0 includes indices i_{l,1} (if reported), i_{1,2} (if reported) and i_{1,8,l} (l=1, . . . , υ).
   Group 1 includes indices i_{1,5} (if reported), i_{1,6,l} (if reported), the υ2LM_{υ}−└K^{NZ}/2┘ highest priority elements of i_{1,7,l}, i_{2,3,l}, the

$$max ( 0 , ⌈ \frac{{K}^{NZ}}{2} ⌉ - v )$$

highest priority elements of i_{2,4,l} and the

$$max ( 0 , ⌈ \frac{{K}^{NZ}}{2} ⌉ - v )$$

highest priority elements of i_{2,5,l} (l=1, . . . , υ).
Group 2 includes the └K^{NZ}/2┘ lowest priority elements of i_{1,7,l}, the

$$min ( {K}^{NZ} - v , ⌊ \frac{{K}^{NZ}}{2} ⌋ )$$

lowest priority elements of i_{2,4,l} and the

$$min ( {K}^{NZ} - v , ⌊ \frac{{K}^{NZ}}{2} ⌋ )$$

lowest priority elements of i_{2,5,l} (l=1, . . . , υ).
For Further Enhanced Type II Port Selection reports, for a given CSI report n, each reported element of i_{2,4,l}, i_{2,3,l} and i_{1,7,l}, indexed by l, i and f, is associated with apriority value Pri(l,i,f)=K₁·υ·f+υ·i+l, with l=1, 2, . . . , υ, i=0, 1, . . . , K₁−1 and f=0, . . . , M−1. The element with the highest priority has the lowest associated value Pri(l,i,f). Omission of Part 2 CSI is according to the priority order shown in Table 5.2.3-1, where:
   Group 0 includes i_{1,2} (if reported), i_{1,8,l}, (l=1, . . . , υ) and i_{1,6} (if reported).
   Group 1 includes the υK₁M−└K^{NZ}/2┘ highest priority elements of i_{1,7,l} (if reported), i_{2,3,l}, the

$$max ( 0 , ⌈ \frac{{K}^{NZ}}{2} ⌉ - v )$$

highest priority elements of i_{2,4,l} and the

$$max ( 0 , ⌈ \frac{{K}^{NZ}}{2} ⌉ - v )$$

highest priority elements of i_{2,5,l} (l=1, . . . , υ).
Group 2 includes the └K^{NZ}/2┘ lowest priority elements of i_{1,7,l} (if reported), the

$$min ( {K}^{NZ} - v , ⌊ \frac{{K}^{NZ}}{2} ⌋ )$$

lowest priority elements of i_{2,4,l} and the

$$min ( {K}^{NZ} - v , ⌊ \frac{{K}^{NZ}}{2} ⌋ )$$

lowest priority elements of i_{2,5,l} (l=1, . . . , υ).
When the UE is scheduled to transmit a transport block on PUSCH not using repetition type B multiplexed with a CSI report(s), Part 2 CSI is omitted only when

$$⌈ ( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l ) / {\sum }_{r = 0}^{{C}_{UL - SCH} - 1} {K}_{r} ⌉$$

is larger than ┌α·Σₗ₌₀^{N}^{_{symb,all}}^{^{PUSCH}}⁻¹M_{sc}^{UCI}(l)┐−Q_{ACK/CG-UCI}′−Q_{CSI-1}′, where parameters O_{CSI-2}, L_{CSI-2}, β_{offset}^{PUSCH}, N_{sym,all}^{PUSCH}, M_{sc}^{UCI}(l), C_{UL-SCH}, Kᵣ, Q′_{CSI-1}, Q_{ACK/GG-UCI}′ and α are defined in Clause 6.3.2.4 of [5, TS 38.212].
Part 2 CSI is omitted level by level, beginning with the lowest priority level until the lowest priority level is reached which causes the

$$⌈ ( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l ) / {\sum }_{r = 0}^{{C}_{UL - SCH} - 1} {K}_{r} ⌉$$

to be less than or equal to ┌α·Σₗ₌₀^{N}^{_{symb,all}}^{^{PUSCH}}⁻¹M_{sc}^{UCI}(l)┐−Q_{ACK/CG-UCI}′−Q_{CSI-1}′.
When the UE is scheduled to transmit a transport block on PUSCH using repetition type B multiplexed with a CSI report(s), Part 2 CSI is omitted only when

$$⌈ ( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l ) / {\sum }_{r = 0}^{{C}_{UL - SCH} - 1} {K}_{r} ⌉$$

is larger than

$$min \{ \begin{matrix}⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} , \\ {\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′}\end{matrix} \} ,$$

where parameters O_{CSI-2}, L_{CSI-2}, β_{offset}^{PUSCH}, N_{symb,nominal}^{PUSCH}, N_{symb,actual}^{PUSCH}, M_{sc,nominal}^{UCI}(l), M_{sc,actual}^{UCI}(l), C_{UL-SCH}, Kᵣ, Q_{ACK/CG-UCI}′, Q_{CSI-1}′, and α are defined in Clause 6.3.2.4 of [5, TS 38.212].
Part 2 CSI is omitted level by level, beginning with the lowest priority level until the lowest priority level is reached which causes

$$⌈ ( {O}_{CSI − 2} + {L}_{CSI − 2} ) \cdot {β}_{offset}^{PUSCH} \cdot {\sum }_{l = 0}^{{N}_{symb , nominal}^{PUSC} − 1} {M}_{sc , nominal}^{UCI} ( l ) / {\sum }_{r = 0}^{{C}_{UL − SCH} − 1} {K}_{r} ⌉$$

to be less than or equal to

$$min \{ \begin{matrix}⌈ α \cdot {\sum }_{l = 0}^{{N}_{symb , nominal}^{PUSCH} − 1} {M}_{sc , nominal}^{UCI} ( l ) ⌉ − {Q}_{ACK / CG − UCI}^{′} − {Q}_{CSI − 1}^{′} , \\ {\sum }_{l = 0}^{{N}_{symb , actual}^{PUSCH} − 1} {M}_{sc , actual}^{UCI} ( l ) − {Q}_{ACK / CG − UCI}^{′} − {Q}_{CSI − 1}^{′}\end{matrix} \} .$$

When part 2 CSI is transmitted on PUSCH with no transport block, lower priority bits are omitted until Part 2 CSI code rate, which is given by (O_{CSI-2}+L_{CSI-2})/(N_{L}·Q′_{CSI,2}·Qₘ) where O_{CSI-2}, L_{CSI-2}, N_{L}, Q′_{CSI,2}, Qₘ are given in clause 6.3.2.4 of [5, 38.212] before HARQ-ACK puncturing part 2 CSI if any, is below a threshold code rate c_{T} lower than one, where

$${c}_{T} = \frac{R}{{β}_{offset}^{CSI - part 2}}$$

β_{offset}^{CSI-part2} is the CSI offset value from Table 9.3-2 of [6, TS 38.213]
R is signaled code rate in DCI

### Priority Rules for CSI Reports

CSI reports are associated with a priority value Pri_{iCSI}(y,k,c,s)=2·N_{cells}·Mₛ·y+N_{cells}·Mₛ·k+Mₛ·c+s where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells;
s is the reportConfigfD and Mₛ is the value of the higher layer parameter maxNrofCSI-ReportConfigurations.
   A first CSI report is said to have priority over second CSI report if the associated Pri_{iCSI}(y,k,c,s) value is lower for the first report than for the second report.

TABLE 52.3-1
Priority reporting levels for Part 2 CSI

Priority 0:
For CSI reports 1 to N_{Rep}, Group 0 CSI for CSI reports configured
as ‘typeII-r16’, ‘typeII-PortSelection-r16’ or ‘typeII-PortSelection-
r17’; Part 2 wideband CSI for CSI reports configured otherwise
Priority 1:
Group 1 CSI for CSI report 1, if configured as ‘typeII-r16’, ‘typeII-
PortSelection-r16’ or ‘typeII-PortSelection-r17’; Part 2 subband
CSI of even subbands for CSI report 1, if configured otherwise
Priority 2:
Group 2 CSI for CSI report 1, if configured as ‘typeII-r16’, ‘typeII-
PortSelection-r16’ or ‘typeII-PortSelection-r17’; Part 2 subband
CSI of odd subbands for CSI report 1, if configured otherwise
Priority 3:
Group 1 CSI for CSI report 2, if configured as ‘typeII-r16’, ‘typeII-
PortSelection-r16’ or ‘typeII-PortSelection-r17’; Part 2 subband
CSI of even subbands for CSI report 2, if configured otherwise
Priority 4:
Group 2 CSI for CSI report 2, if configured as ‘typeII-r16’, ‘typeII-
PortSelection-r16’ or ‘typeII-PortSelection-r17’. Part 2 subband
CSI of odd subbands for CSI report 2, if configured otherwise
.
.
.
Priority 2N_{Rep} − 1:
Group 1 CSI for CSI report N_{Rep}, if configured as ‘typeII-r16’,
‘typeII-PortSelection-r16’ or ‘typeII-PortSelection-r17’; Part 2
subband CSI of even subbands for CSI report N_{Rep}, if
configured otherwise
Priority 2N_{Rep}:
Group 2 CSI for CSI report N_{Rep}, if configured as ‘typeII-r16’,
‘typeII-PortSelection-r16’ or ‘typeII-PortSelection-r17’; Part 2
subband CSI of odd subbands for CSI report N_{Rep}, if
configured otherwise

In Release 15, 16 or 17, CSI omission is defined based on priority levels. In detail, Part 2 CSI is omitted level by level, beginning with the lowest priority level until the priority level at which target data rate requirement is met. The priority levels are assigned, from high priority to low priority, firstly to CSI group 0 from all CSI reports in PUSCH and then to group 1 and 2 for CSI report 1, CSI report 2, . . . , CSI report n, respectively.

For CJT, enhanced codebook is designed for CSI reporting for multiple TRPs. Some enhancements on CSI reports, e.g., joint beam selection, joint FD basis selection, additional co-phasing and/or co-amplitude information, may be considered. For CSI omission which is related with CSI report design, there is no discussion yet in Release 18 MIMO.

In this disclosure, CSI omission schemes for CSI reporting for coherent joint transmission are proposed. The details of CSI omission schemes with special consideration for coherent joint transmission, such as enhanced priority levels with finer omission granularity, omission order for priority levels with finer granularity, CSI bits for multiple TRPs in group 1 or group 2 for omission determined by a newly proposed bit priority rule, optimized schemes for determining priority levels for omission on account of different overhead between CSI report for CJT and for single TRP transmission, are discussed.

When uplink channel quality is not good enough to carry CSI bits for all the CSI reports, the UE may omit a portion of the Part 2 CSI. The conventional CSI omission is defined based on priority levels for CSI reports for single TRP transmission, which are defined as in Table 5.2.3-1 in TS 38.214. For CJT CSI report, the reporting contents may include CSI for multiple TRPs including a maximum of N (e.g. N=4) cooperative TRPs.

In this disclosure, multiple CSI omission schemes for CJT CSI reporting are proposed based on different CSI omission granularities and different bit selection and sorting schemes for CJT CSI bit group 1 or 2.

CSI Omission Based on New Priority Levels with Finer Omission Granularity Defined per TRP

For Type2 codebook refinement for CJT, per-TRP or per TRP group (port-group or resource) designed codebook is agreed as one option. Here, SD or FD basis selection, and relative co-phasing and/or co-amplitude (including WB and/or SB) per-TRP or per TRP group may be reported. Based on this option, Part 2 CSI may include PMIs for multiple cooperative TRPs, amplitude and phase adjustment indication bits if introduced. For PMI for multiple cooperative TRPs, it may include multiple CSI bit groups, e.g., group 0/1/2 for each TRP. Following this option for codebook design, the CSI omission may be made based on the new priority levels defined based on CSI bits from each TRP.

In principle, extension for priority levels may be made on account of CJT CSI report including CSI bits for N cooperative TRPs. That is, multiple priority levels are introduced for one CJT CSI report and each priority level corresponds to CSI report for one TRP in one CJT CSI report. In detail, two schemes may be used for defining priority rule or priority order, which are shown in Table 1 and Table 2, respectively.

In the disclosure, priority levels may also be referred to as priority reporting levels; and the two terms may be used interchangeably.

For scheme 1 as shown in Table 1, the priority levels are defined firstly for group 1 corresponding TRP1, . . . , TRP_N, and then for group 2 corresponding TRP1, . . . , TRP_N. That is, for a CSI report X configured for CJT transmission (i.e., configured as ‘typeII-CJT-r18 or ‘typeII-PortSelection-CJT-r18’), there are 2N priority levels, where N is the cooperative TRP number for CJT; and part of group 1 corresponding CSI for TRP1, . . . , TRP_N in CSI report X are assigned with Priority K, . . . , Priority K+N, respectively, and part of group 2 corresponding CSI for TRP1, . . . , TRP_N in CSI report X are assigned with Priority K+N+1, . . . , Priority K+2N, respectively.

This scheme provides high priority for CSI bit group 1 of multiple TRPs. It is a better scheme if CJT is transmitted based on partially omitted CSI since CSI bit group 1 of all cooperative TRPs may still be available.

TABLE 1
Enhanced Priority Reporting Levels for CJT Part 2 CSI

Priority 0:
For CSI reports 1 to N_{Rep}, Group 0 CSI for CSI reports configured
as ‘typeII-r16’, ‘typeII-PortSelection-r16’ or ‘typeII-PortSelection-
r17’; Group 0 CSI for all configured or selected cooperative TRP1,
TRP2, . . . , TRP_N for CSI reports configured as ‘typeII-CJT-r18’
or ‘typeII-PortSelection-CJT-r18’; Part 2 wideband CSI for CSI
reports configured otherwise
. . .
Priority K + 1:
Part of Group 1 corresponding CSI for TRP1 in CSI report X
configured as ‘typeII-CJT-r18 or ‘typeII-PortSelection-CJT-r18’
. . .
Priority K + N:
Part of Group 1 corresponding CSI for TRP_N in CSI report X
configured as ‘typeII-CJT-r18 or ‘typeII-PortSelection-CJT-r18’
Priority K + N + 1:
Part of Group 2 corresponding CSI for TRP1 in CSI report X
configured as ‘typeII-CJT-r18 or ‘typeII-PortSelection-CJT-r18’
. . .
Priority K + 2N:
Part of Group 2 corresponding CSI for TRP_N in CSI report X
configured as ‘typeII-CJT-r18 or ‘typeII-PortSelection-CJT-r18’
. . .

For scheme 2 as shown in Table 2, the priority levels are defined first for group 1, group 2 corresponding to one TRP, and then for group 1, group 2 corresponding to the next cooperative TRP, and so on, until the last cooperative TRP. That is, for a CSI report X configured for CJT transmission (i.e., configured as ‘typeII-CJT-r18 or ‘typeII-PortSelection-CJT-r18’), there are 2N priority levels, where N is the cooperative TRP number for CJT; and part of group 1 corresponding CSI for TRP1 and part of group 2 corresponding CSI for TRP1 in CSI report X are assigned with Priority K and Priority K+1, respectively, and part of group 1 corresponding CSI for TRP_N and part of group 2 corresponding CSI for TRP_N in CSI report X are assigned with Priority K+2N−1 and Priority K+2N, respectively.

This scheme provides high priority for CS from TRP with smaller index between different groups. It is a better scheme if fallback to single TRP transmission or low order CJT is considered.

TABLE 2
Enhanced Priority Reporting Levels for CJT Part 2 CSI

Priority 0:
For CSI reports 1 to NRep, Group 0 CSI for CSI reports configured
as ‘typeII-r16’, ‘typeII-PortSelection-r16’ or ‘typeII-PortSelection-
r17’; Group 0 CSI for all configured or selected cooperative TRP1,
TRP2, . . . , TRP_N for CSI reports configured as ‘typeII-CJT-r18
or ‘typeII-PortSelection-CJT-r18’; Part 2 wideband CSI for CSI
reports configured otherwise
. . .
Priority K + 1:
Part of Group 1 corresponding CSI for TRP1 in CSI report X
configured as ‘typeII-CJT-r18 or ‘typeII-PortSelection-CJT-r18’
Priority K + 2:
Part of Group 2 corresponding CSI for TRP1 in CSI report X
configured as ‘typeII-CJT-r18 or ‘typeII-PortSelection-CJT-r18’
. . .
Priority K + 2N − 1:
Part of Group 1 corresponding CSI for TRP_N in CSI report X
configured as ‘typeII-CJT-r18 or ‘typeII-PortSelection-CJT-r18’
Priority K + 2N:
Part of Group 2 corresponding CSI for TRP_N in CSI report X
configured as ‘typeII-CJT-r18 or ‘typeII-PortSelection-CJT-r18’
. . .

In summary, for both schemes, the priority levels are defined based on bit group corresponding to one cooperative TRP in one CSI reporting. It has similar dropping granularity as that for single TRP transmission.

For priority 0 for both schemes, it includes group 0 CSI for CSI reports i to N_{Rep}. For CJT CSI report, it may include group 0 CSI for all configured or selected cooperative TRP1, TRP2, . . . , TRP_N. Since overhead of CSI bit group 0 is not so large as that of CSI bit group 1 or 2, it is not necessary to introduce new priority levels for bit group 0 of each TRP. Thus, only one priority level 0 is defined for one CSI report configured as ‘typeII-CJT-r18’ or ‘typeII-PortSelection-CJT-r18’, which may include group 0 CSI for all configured cooperative TRP1, TRP2, . . . , TRP_N.

One CSI report may be assumed to be configured for CJT transmission and the priorities for CSI reports are the same as legacy scheme defined in section of 5.2.5 of TS 38.214, i.e., the CSI report n corresponds to the CSI report with the nth smallest Pri_{i,CSI}(y,k,c,s).

There is implicit association between TRP and CSI-RS resource or CSI-RS port group. Thus, TRP index may not be obviously configured but may be implicitly determined by the configured CSI-RS resource index or CSI-RS port group index of one CSI-RS resource.

Some optimization may be made for scheme 1 and scheme 2 on the order of priority levels corresponding to TPRs. In principle, the higher priority may be assigned to CSI bits for the TRP with better channel quality. For example, the higher priority level for CSI bits for one TRP may be determined based on RSRP of cooperative TRPs with higher priority for the TRP with higher RSRP value.

In some examples, if small numbers of bits are used for indicating amplitude and/or phase adjustments, these bits may be embedded in the last part of group 1 or 2 for some TRPs if existed. The priority level is not changed with introducing amplitude and phase adjustment bits. In some other examples, if large numbers of bits are used for indicating amplitude and/or phase adjustments, these bits may compose a newly defined group 3 and one or more new priority levels may be introduced for group 3 (similar to group 2 with definition per TRP). The additional priority levels for group 3 may be defined as following group 2 in either scheme 1 or scheme 2.

In legacy scheme, UE shall omit all of the information at a priority level; and both schemes 1 and 2 may follow this principle. In some examples, if CSI omission can be made for part of CSI on one priority level, the priority reporting level as Table 5.2.3-1 may be reused. That is, within each priority reporting level of the CSI bits as defined in Table 5.2.3-1, different parts of the CSI bits may be considered sub-levels, and may be omitted based on the sub-level. The similar omission scheme may be used with omission of part of CSI bits corresponding to one TRP on one priority level, which is the same as CSI bits on one priority level for group 1 or 2 in the proposed scheme 1.

CSI Omission Based on Legacy Priority Level Table with CSI Bits for Multiple TRPs

### Bit Selection and Sorting for Group 1 or 2

For Type2 codebook refinement for CJT, joint SD-FD basis selection or joint FD basis selection (across N TRPs) is also agreed as options in addition to per-TRP or per TRP group based SD or FD selection. Here, CSIs for multiple TRPs may be jointly determined for reporting. From the view of single TRP transmission, the reported CSI may not be optimal since it is decided based on CJT transmission. Based on this option, part 2 CSI may include joint PMI for multiple cooperative TRPs, amplitude and phase adjustment indication bits if introduced. For joint PMI for multiple cooperative TRPs, it may include group 0/1/2 including CSI bits for all cooperative TRPs. Here, group 0, 1 or 2 include joint CSI bits for TRP1, TRP2, . . . , TRP_N. It is assumed that the CSI omission may be made based on the group 0, 1 or 2 defined in legacy scheme, i.e., Table 5.2.3-1 of TS 38.214, since CSI report contents are determined based on CJT. Thus, the omission is made with a coarse granularity since CSI bits in group 0/1/2 may include CSI from TRP1, TRP2, . . . , TRP_N. Here, the bits in group 1 and 2 should be redefined based on bit priority since bits from multiple TRPs are included in group 1 or 2 and the legacy system only defines bit priority for CSI report for single TRP transmission.

For enhanced Type II reports in legacy system, each reported element of amplitude indication indices for nonzero elements in linear combination matrix i_{2,4,l}, phase indication indices for nonzero element in linear combination matrix i_{2,5,l} and bitmap indication bits for non-zero elements in linear combination matrix i_{1,7,l}, indexed by l, i and f, is associated with a priority value Pri(l,i,f)=2·L·υ·π(f)+υ·i+l, with π(f)=min (2·n_{3,l}^{(f)}, 2·(N₃−n_{3,l}^{(f)})−1) with l=1, 2, . . . , υ, denoting layer index; i=0, 1, . . . , 2L−1, denoting beam index; and f=0, 1, . . . , M_{υ}−1, and where n_{3,l}^{(f)}, denoting base index in the linear transformation domain, is defined in Clause 5.2.2.2.5 of TS 38.214. The element with the highest priority has the lowest associated value Pri(l,i,f). Group 1 includes indices υ2LM_{υ}−└K^{NZ}/2┘ highest priority elements of i_{1,7,l}, the

$$max ( 0 , ⌈ \frac{{K}^{N Z}}{2} ⌉ - υ )$$

highest priority elements of i_{2,4,l} and the

$$max ( 0 , ⌈ \frac{{K}^{N Z}}{2} ⌉ - υ )$$

highest priority elements of i_{2,5,l} (l=1, . . . , υ). Group 2 includes the └K^{NZ}/2┘ lowest priority elements of i_{1,7,l}, the

$$min ( {K}^{N Z} - v , ⌊ \frac{{K}^{N Z}}{2} ⌋ )$$

lowest priority elements of i_{2,4,l} and the

$$min ( {K}^{N Z} - v , ⌊ \frac{{K}^{N Z}}{2} ⌋ )$$

lowest priority elements of i_{2,5,l} (l=1, . . . , υ). For further enhanced Type II port selection codebook, for a given CSI report n, each reported element of i_{2,4,l} i_{2,5,l} and i_{1,7,l}, indexed by l, i and f, is associated with a priority value Pri(l,i,f)=K₁·υ·f+υ·i+l, with l=1, 2, . . . , υ, i=0, 1, . . . , K₁−1 and f=0, . . . , M−1. The element with the highest priority has the lowest associated value Pri(l,i,f). Group 0 includes i_{1,2} (if reported), i_{1,8,l} (l=1, . . . , υ) and i_{1,6} (if reported). Group 1 includes the υK₁M−└K^{NZ}/2┘ highest priority elements of i_{1,7,l} (if reported), i_{2,3,l}, the

$$max ( 0 , ⌈ \frac{{K}^{N Z}}{2} ⌉ - υ )$$

highest priority elements of i_{2,4,l} and the

$$max ( 0 , ⌈ \frac{{K}^{N Z}}{2} ⌉ - υ )$$

highest priority elements of i_{2,5,l} (l=1, . . . , υ). Group 2 includes the └K^{NZ}/2┘ lowest priority elements of i_{1,7,l} (if reported), the

$$min ( {K}^{N Z} - v , ⌊ \frac{{K}^{N Z}}{2} ⌋ )$$

lowest priority elements of i_{2,4,l} and the

$$min ( {K}^{N Z} - v , ⌊ \frac{{K}^{N Z}}{2} ⌋ )$$

lowest priority elements of i_{2,5,l} (l=1, . . . , υ).

For enhanced Type II codebook and further enhanced Type II Port selection codebook for CJT, bit priority may be defined in two kinds of schemes.

### First Kind of Schemes

For the first kind of schemes, the bit priority is defined by adding new dimension for TRPs. The enhanced priority definition schemes are related with the layer number, selection beam number, and/or basis number. Some assumptions are made:
The layer number is the same for multiple TRPs since the same information is transmitted from multiple TRPs.
For typical configuration, the same value is assumed for the number of selected beams and selected basis vectors for linear transformation domain. If different values are defined for some optimization, the maximum value among multiple TRPs may be used in the following formula. In detail, L is the maximum number of selected beams among multiple TRPs. M_{υ} is the maximum number of selected basis in the transformation domain among multiple TRPs.
Total number of non-zero coefficients across all layers and TRPs is K^{NZ}.

The bit priority for group 1 and 2 for CJT may be defined according to two schemes using the following formulae:

$$\begin{matrix}Pri ( l , i , f , n ) = 2 \cdot N \cdot L \cdot υ \cdot π ( f ) + N \cdot υ \cdot i + N \cdot ( l - 1 ) + n \\ ( n = 1 , … , N ; l = 1 , 2 , … , υ ; i = 0 , 1 , … , 2 L - 1 ; f = 0 , 1 , … , {M}_{υ} )\end{matrix} \qquad Scheme 1$$

$$\begin{matrix}Pri ( l , i , f , n ) = 2 \cdot n \cdot L \cdot υ \cdot {M}_{υ} + 2 \cdot L \cdot υ \cdot π ( f ) + υ \cdot i + l \\ ( n = 0 , … , N - 1 ; l = 1 , 2 , … , υ ; i = 0 , 1 , … , 2 L - 1 ; f = 0 , 1 , … , {M}_{υ} - 1 )\end{matrix} \qquad Scheme 2$$

where N is the cooperative TRP number for CJT; L is the selected beam number for CJT; υ is the layer number for CJT; M_{υ} is the selected basis number for CJT; n denotes TRP index (i.e. index of configured CSI-RS resource or port group index of one CSI-RS resource); l denotes the layer index; i denotes the beam index, f denotes the basis index in transform domain.

That is, for enhanced Type II reports for CJT or further enhanced Type II Port selection codebook where n denotes the TRP index of the cooperative TRPs, each reported element of amplitude indication indices for nonzero elements in linear combination matrix i_{2,4,l}, phase indication indices for nonzero element in linear combination matrix i_{2,5,l} and bitmap indication bits for non-zero elements in linear combination matrix i_{1,7,l}, indexed by l, i and f, is associated with a priority value Pri(l,i,f,n) defined according to one of the above formulae. The element with the highest priority has the lowest associated value Pri(l,i,f,n).

Group 1 includes indices Nυ2LM_{υ}−└K^{NZ}/2┘ highest priority elements of i_{1,7,l} for enhanced Type II reports for CJT or indices NυK₁M_{υ}−└K^{NZ}/2┘ highest priority elements of i_{1,7,l} for further enhanced Type II port selection reports for CJT, the

$$max ( 0 , ⌈ \frac{{K}^{N Z}}{2} ⌉ - N υ )$$

highest priority elements of i_{2,4,l} and the

$$max ( 0 , ⌈ \frac{{K}^{N Z}}{2} ⌉ - N υ )$$

highest priority elements of i_{2,5,l} (l=1, . . . , υ). Group 2 includes the └K^{NZ}/2┘ lowest priority elements of i_{1,7,l}, the

$$min ( {K}^{N Z} - Nv , ⌊ \frac{{K}^{N Z}}{2} ⌋ )$$

lowest priority elements of i_{2,4,l} and the

$$min ( {K}^{N Z} - Nv , ⌊ \frac{{K}^{N Z}}{2} ⌋ )$$

lowest priority elements of i_{2,5,l} (l=1, . . . , υ). For each item of i_{1,7,l}, i_{2,4,l}, i_{2,5,l} in group 1 or 2, the bits are concatenated with a decreasing order of priority based on the proposed function Pri(l,i,f,n).

For scheme 1, the CSI bit priorities are made with first level on TRP index, second level on layer index, third level on beam index, and last level on basis index, and index from small to large on one level. In this example, a smaller index or ID represents a higher priority. The higher priority may be given to some CSI bits for all cooperative TRPs. It is proposed for the case that CSI after omission can still be used for CJT transmission when group 1 is reported but group 2 is dropped.

For scheme 2, the CSI bit priorities are made with first level on layer index, second level on beam index, third level on basis index, and last level on TRP index, and index from small to large on one level. In this example, a smaller index or ID represents a higher priority. The higher priority may be given to CSI bits for the TRP with lower ID. It is proposed for the case that CSI report can still be used for fallback with single TRP transmission or low order CJT transmission when bit group 1 is reported but bit group 2 is dropped.

In some examples, other bit priority definition schemes, such as a scheme in the order of {first level layer index, then TRP index, next beam index, finally basis index}; or a scheme in the order of {first level layer index, then beam index, next TRP index, finally basis index}, may be possible, and the possible rules may be generated by combination.

For other reporting items, e.g. i_{1,5} (if reported), i_{1,6,l} (if reported), and i_{2,3,l} in group 1, these CSI bits can be concatenated according to the TRP index for enhanced Type II reports. There are no other items except i_{1,7,l}, i_{2,4,l}, i_{2,5,l} for enhanced Type II port selection reports for CJT.

For priority 0 for both schemes, it includes group 0 CSI for CSI reports 1 to N_{Rep}. For CJT CSI report, it may include group 0 CSI for all configured or selected cooperative TRP1, TRP2, . . . , TRP_N. Thus, only one priority level 0 is defined for one CSI report configured as ‘typeII-CJT-r18’ or ‘typeII-PortSelection-CJT-r18’, which may include group 0 CSI for all configured cooperative TRP1, TRP2, . . . , TRP_N. For enhanced Type II reports, it may include indices i_{1,1} (if reported), i_{1,2} (if reported) and i_{1,8,l} (l=1, . . . , υ). For further enhanced Type II port selection reports, it may include i_{1,2} (if reported), i_{1,8,l} (l=1, . . . , υ) and i_{1,6} (if reported).

In some examples, if small numbers of bits are used for indicating amplitude and/or phase adjustments, these bits may be embedded in the last part of group 1 or 2 for some TRPs if existed. The priority level is not changed with introducing amplitude and phase adjustment bits. In some other examples, if large numbers of bits are used for indicating amplitude and/or phase adjustments, these bits may compose a newly defined group 3 and one or more new priority levels may be introduced for group 3. The additional priority levels for group 3 may be defined as following group 2.

### Second Kind of Schemes

For the second kind of schemes, it reuses the bit priority formula for each TRP. The group 0, 1 or 2 may be defined or updated with new mapping order for CSI between TRPs. The CSI omission is made based on legacy table, i.e., Table 5.2.3-1, for priority reporting levels, but with contents in updated group 1 or 2. For example, the items in group 1 or 2, such as i_{1,7,l}, i_{2,4,l}, i_{2,5,l}, may be concatenated with two schemes.

For scheme 1, the mapping order is firstly all items for the first TRP with the lowest index and then all items for the second TRP with larger index, and so on until the last TRP with the largest index. For scheme 2, the mapping order is the first item for all cooperative TRPs and then the second item for all cooperative TRPs, and so on until the last item for all cooperative TRPs.

In scheme 1 for enhanced Type II reports for CJT, Group 1 includes indices with the following mapping order: i_{1,5} (if reported) for TRP1, i_{1,6,l} (if reported) for TRP1, υ2LM_{υ}−└K₁^{NZ}/2┘ highest priority elements of i_{1,7,l} for TRP1, i_{2,3,l} for TRP1, the

$$max ( 0 , ⌈ \frac{{K}_{1}^{N Z}}{2} ⌉ - υ )$$

highest priority elements of i_{2,4,l} for TRP1, and the

$$max ( 0 , ⌈ \frac{{K}_{1}^{N Z}}{2} ⌉ - υ )$$

highest priority elements of i_{2,5,l} (l=1, . . . , υ) for TRP1; . . . ; i_{1,5} (if reported) for TRP_N, i_{1,6,l} (if reported) for TRP_N, υ2LM_{υ}−└K_{N}^{NZ}/2┘ highest priority elements of i_{1,7,l} for TRP_N, i_{2,3,l} for TRP_N, the

$$max ( 0 , ⌈ \frac{{K}_{N}^{N Z}}{2} ⌉ - υ )$$

highest priority elements of i_{2,4,l} for TRP_N, and the

$$max ( 0 , ⌈ \frac{{K}_{N}^{N Z}}{2} ⌉ - υ )$$

highest priority elements of i_{2,5,l} (l=1, . . . , υ) for TRP_N. Group 2 includes the └K₁^{NZ}/2┘ lowest priority elements of i_{1,7,l} for TRP1, the

$$min ( {K}_{1}^{NZ} - ν , ⌊ \frac{{K}_{1}^{N Z}}{2} ⌋ )$$

lowest priority elements of i_{2,4,l} for TRP1, and the

$$min ( {K}_{1}^{NZ} - ν , ⌊ \frac{{K}_{1}^{N Z}}{2} ⌋ )$$

lowest priority elements of i_{2,5,l} (l=1, . . . , υ) for TRP1, . . . , the └K_{N}^{NZ}/2┘ lowest priority elements of i_{1,7,l} for TRP_N the min

$$min ( {K}_{N}^{NZ} - ν , ⌊ \frac{{K}_{N}^{N Z}}{2} ⌋ )$$

lowest priority elements of i_{2,4,l} for TRP_N, and the

$$min ( {K}_{N}^{NZ} - ν , ⌊ \frac{{K}_{N}^{N Z}}{2} ⌋ )$$

lowest priority elements of i_{2,5,l} (l=1, . . . , υ) for TRP_N.

In scheme 1 for further enhanced Type II port selection reports for CJT, Group 1 includes indices with the following mapping order: υK₁M−└K₁^{NZ}/2┘ highest priority elements of i_{1,7,l} for TRP1, the

$$max ( 0 , ⌈ \frac{{K}_{1}^{N Z}}{2} ⌉ - υ )$$

highest priority elements of i_{2,4,l} for TRP1, and the

$$max ( 0 , ⌈ \frac{{K}_{1}^{N Z}}{2} ⌉ - υ )$$

highest priority elements of i_{2,5,l} (l=1, . . . , υ) for TRP1; . . . ; υK₁M−└K_{N}^{NZ}/2┘ highest priority elements of i_{1,7,l} for TRP_N, the

$$max ( 0 , ⌈ \frac{{K}_{N}^{N Z}}{2} ⌉ - υ )$$

highest priority elements of i_{2,4,l} for TRP_N, and the

$$max ( 0 , ⌈ \frac{{K}_{N}^{N Z}}{2} ⌉ - υ )$$

highest priority elements of i_{2,5,l} (l=1, . . . , υ) for TRP_N. Group 2 includes the └K₁^{NZ}/2┘ lowest priority elements of i_{1,7,l} for TRP1, the

$$min ( {K}_{1}^{NZ} - ν , ⌊ \frac{{K}_{1}^{N Z}}{2} ⌋ )$$

lowest priority elements of i_{2,4,l} for TRP1, and the

$$min ( {K}_{1}^{NZ} - ν , ⌊ \frac{{K}_{1}^{N Z}}{2} ⌋ )$$

lowest priority elements of i_{2,5,l} (l=1, . . . , υ) for TRP1, . . . , the └K_{N}^{NZ}/2┘ lowest priority elements of i_{1,7,l} for TRP_N, the

$$min ( {K}_{N}^{NZ} - ν , ⌊ \frac{{K}_{N}^{N Z}}{2} ⌋ )$$

lowest priority elements of i_{2,4,l} for TRP_N and the

$$min ( {K}_{N}^{NZ} - v , ⌊ \frac{{K}_{N}^{NZ}}{2} ⌋ )$$

lowest priority elements of i_{2,5,l} (l=1, . . . , υ) for TRP_N.

In scheme 2 for enhanced Type II reports for CJT, Group 1 includes indices with the following mapping order: i_{1,5} (if reported) for TRP1, . . . , TRP_N, i_{1,6,l} (if reported) for TRP1, . . . , TRP_N

$$υ 2 {LM}_{υ} - ⌊ \frac{{K}_{1}^{NZ}}{2} ⌋ ,$$

. . . ,

$$υ 2 {LM}_{υ} - ⌊ \frac{{K}_{N}^{NZ}}{2} ⌋$$

highest priority elements of i_{1,7,l} for TRP1, . . . , TRP_N, i_{2,3,l} for TRP1, . . . , TRP_N, the

$$max ( 0 , ⌈ \frac{{K}_{1}^{NZ}}{2} ⌉ - υ ) ,$$

. . . ,

$$max ( 0 , ⌈ \frac{{K}_{N}^{NZ}}{2} ⌉ - υ )$$

highest priority elements of i_{2,4,l} for TRP1, . . . , TRP_N and the

$$max ( 0 , ⌈ \frac{{K}_{1}^{NZ}}{2} ⌉ - υ )$$

. . . ,

$$max ( 0 , ⌈ \frac{{K}_{N}^{NZ}}{2} ⌉ - υ )$$

highest priority elements of i_{2,5,l} (l=1, . . . , υ) for TRP1, . . . , TRP_N. Group 2 includes the └K₁^{NZ}/2┘, . . . , └K_{N}^{NZ}/2┘ lowest priority elements of i_{1,7,l} for TRP1, . . . , TRP_N, the

$$min ( {K}_{1}^{NZ} - v , ⌊ \frac{{K}_{1}^{NZ}}{2} ⌋ ) ,$$

. . . ,

$$min ( {K}_{N}^{NZ} - v , ⌊ \frac{{K}_{N}^{NZ}}{2} ⌋ )$$

lowest priority elements of i_{2,4,l} for TRP1, . . . , TRP_N and the

$$min ( {K}_{1}^{NZ} - v , ⌊ \frac{{K}_{1}^{NZ}}{2} ⌋ )$$

. . . ,

$$min ( {K}_{N}^{NZ} - v , ⌊ \frac{{K}_{N}^{NZ}}{2} ⌋ )$$

lowest priority elements of i_{2,5,l} (l=1, . . . , υ) for TRP1, . . . , TRP_N.

In scheme 2 for further enhanced Type II port selection reports for CJT, Group 1 includes indices with the following mapping order: υK₁M−└K₁^{NZ}/2┘, . . . , υK₁M−└K_{N}^{NZ}/2┘ highest priority elements of i_{1,7,l} for TRP1, . . . , TRP_N, the

$$max ( 0 , ⌈ \frac{{K}_{1}^{NZ}}{2} ⌉ - υ ) ,$$

. . . ,

$$max ( 0 , ⌈ \frac{{K}_{N}^{NZ}}{2} ⌉ - υ )$$

highest priority elements of i_{2,4,l} for TRP1, . . . , TRP_N and the

$$max ( 0 , ⌈ \frac{{K}_{1}^{NZ}}{2} ⌉ - υ )$$

. . . ,

$$max ( 0 , ⌈ \frac{{K}_{N}^{NZ}}{2} ⌉ - υ )$$

highest priority elements of i_{2,5,l} (l=1, . . . , υ) for TRP1, . . . , TRP_N. Group 2 includes the └K₁^{NZ}/2┘, . . . , └K_{N}^{NZ}/2┘ lowest priority elements of i_{1,7,l} for TRP1, . . . , TRP_N, the

$$min ( {K}_{1}^{NZ} - v , ⌊ \frac{{K}_{1}^{NZ}}{2} ⌋ ) ,$$

. . . ,

$$min ( {K}_{N}^{NZ} - v , ⌊ \frac{{K}_{N}^{NZ}}{2} ⌋ )$$

lowest priority elements of i_{2,4,l} for TRP1, TRP_N and the

$$min ( {K}_{1}^{NZ} - v , ⌊ \frac{{K}_{1}^{NZ}}{2} ⌋ )$$

. . . ,

$$min ( {K}_{N}^{NZ} - v , ⌊ \frac{{K}_{N}^{NZ}}{2} ⌋ )$$

lowest priority elements of i_{2,5,l} (l=1, . . . , υ) for TRP1, . . . , TRP_N.

For priority 0 for both schemes, it includes group 0 CSI for CSI reports 1 to N_{Rep}. For CJT CSI report, it may include group 0 CSI for all configured or selected cooperative TRP1, TRP2, . . . , TRP_N. Thus, only one priority level 0 is defined for one CSI report configured as ‘typeII-CJT-r18’ or ‘typeII-PortSelection-CJT-r18’, which may include group 0 CSI for all configured cooperative TRP1, TRP2, . . . , TRP_N. For enhanced Type II reports, it may include indices i_{1,1} (if reported), i_{1,2} (if reported) and i_{1,8,l} (l=1, . . . , υ). For further enhanced Type II port selection reports, it may include i_{1,2} (if reported), i_{1,8,l} (l=1, . . . , υ) and i_{1,6} (if reported). They may be sorted, according to the first scheme with first item index then TRP index, or according to the second scheme with first TRP index then item index.

In some examples, if small numbers of bits are used for indicating amplitude and/or phase adjustments, these bits may be embedded in the last part of group 1 or 2 for some TRPs if existed. The priority level is not changed with introducing amplitude and phase adjustment bits. In some other examples, if large numbers of bits are used for indicating amplitude and/or phase adjustments, these bits may compose a newly defined group 3 and one or more new priority levels may be introduced for group 3. The additional priority levels for group 3 may be defined as following group 2.

### Optimization for Priority Level Selection for CSI Omission

For legacy CSI omission scheme, omission of Part 2 CSI is based on the priority levels. When omitting Part 2 CSI information for a particular priority level, the UE shall omit all of the information at that priority level. For example, when the UE is scheduled to transmit a transport block on PUSCH not using repetition type B multiplexed with a CSI report(s), Part 2 CSI is omitted level by level, beginning with the lowest priority level until the lowest priority level is reached which causes the

$$⌈ ( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l ) / {\sum }_{r = 0}^{{C}_{UL - SCH} - 1} {K}_{r} ⌉$$

to be less than or equal to ┌α·Σₗ₌₀^{N}^{_{symb,all}}^{^{PUSCH}}⁻¹M_{sc}^{UCI}(l)┐−Q_{ACK/CG-UCI}′−Q_{CSI-1}′, where O_{CSI-2} includes all part 2 CSI with priority level without omission. The principle for determining maximum part 2 CSI overhead is defined by the following formula (1), which guarantees that the used spectrum efficiency is no larger than scaling value. This condition may be reused for CSI omission for CJT report in PUSCH.

$$⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ \leq ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \qquad ( 1 )$$

For CJT, CSI on a priority level may include CSI from multiple cooperative TRPs as shown in bit selection and sorting for group 1 or 2 for enhanced Type II codebook for CJT. The CSI overhead on a priority level (e.g., group 1 or 2 of a CSI reporting) for CSI report for CJT may be multiple of CSI overhead on the similar priority level (e.g. group 1 or 2 of a CSI reporting) for CSI report for single TRP transmission. When PUSCH cannot carry CSI bits on a priority level corresponding to CSI report for CJT, it is possible to carry CSI on the next lower priority level (i.e., larger priority level index) if these CSI bits on the lower priority level are from CSI report for single TRP transmission. In this case, it is beneficial to include CSI bits on the next lower priority level for PUSCH transmission.

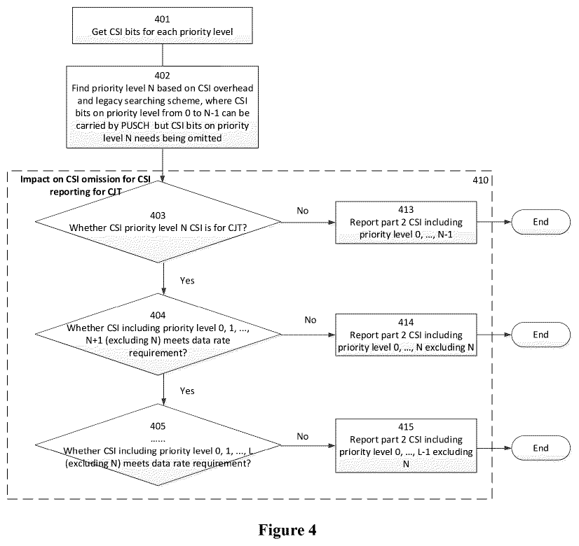

FIG. 4 is a schematic diagram illustrating an example of updated procedure for CSI omission in the case of CSI reporting including CSI for CJT in accordance with some implementations of the present disclosure. As shown in FIG. 4, the modules in the box 410 of dashed lines represent the improvement for CJT CSI omission. In detail, the ULE may get the CSI bits for each priority level 401; and subsequently find priority level N based on CSI overhead and legacy searching scheme, where CSI bits on priority levels from 0 to N−1 can be carried by PUSCH but CSI bits on priority level N needs being omitted 402.

With the improved CSI omission scheme, it first determines whether CSI priority level N CSI is for CJT 403. If not, it reports part 2 CSI including priority level 0, . . . N−1 413, which ends the CSI omission process.

If the determination in step 403 is yes, it further determines whether CSI including priority level 0, 1, . . . , N+1 (excluding N) meets data rate requirement 404. If not, it reports part 2 CSI including priority level 0, . . . , N excluding N 414, which ends the CSI omission process.

The CSI on a lower priority level N+1 is checked that whether it can be carried by PUSCH when its higher priority level includes a CJT CSI, which cannot be carried by PUSCH based on legacy omission rule. If the requirement of the spectrum efficiency can be met (i.e. formula 1 can be met), CSI bits on priority level 0, 1, . . . , N+1 but excluding level N can be carried by PUSCH; otherwise, CSI bits on priority level 0, 1, . . . , N−1 are carried by PUSCH.

If the determination in step 404 is yes, it continues the determination with further priority levels, until it determines that CSI including priority level 0, 1, . . . , L (excluding N) does not meet data rate requirement, it reports part 2 CSI including priority level 0, . . . , L−1 excluding N.

Moreover, the restriction may be introduced to reduce realization complexity. In detail, the CSI bits on the checked priority level should be from CSI report for single TRP transmission or CSI report for lower order CJT (i.e. CJT with smaller number of cooperative TRPs). As shown in FIG. 4, if CSI bits on priority level 0, 1, . . . , N+1 but excluding level N can be carried by PUSCH, bits on the next lower priority level(s) such as N+2 until L (L>N+1) may be checked that whether they can be carried by PUSCH. When the requirement of the spectrum efficiency cannot be met if CSI bits on priority level L are included, CSI bits including priority level 0, 1, . . . L−1 excluding N can be reported by PUSCH.

Alternatively, some restriction may be made for the configuration of CSI reports. In detail, the CSI report for CJT is configured with larger ID than CSI report for single TRP transmission. In this way, priority level for CSI report for CJT may be firstly omitted. Thus, there is no mentioned issue caused by larger CSI overhead on the priority level for CSI report for CJT. However, this will cause restriction on the flexibility of gNB's realization.

FIG. 5 is a flow chart illustrating steps of CSI omission for coherent joint transmission by UE 200 in accordance with some implementations of the present disclosure.

At step 502, the receiver 214 of UE 200 receives a configuration signalling for one or more Channel State Information (CSI) reports for coherent joint transmission (CJT) with a plurality of transmitting-receiving identities.

At step 504, the processor 202 of UE 200 determines a portion of the CSI reports that is to be omitted in transmission based on a CSI omission scheme.

At step 506, the transmitter 212 of UE 200 transmits the CSI reports with the portion being omitted.

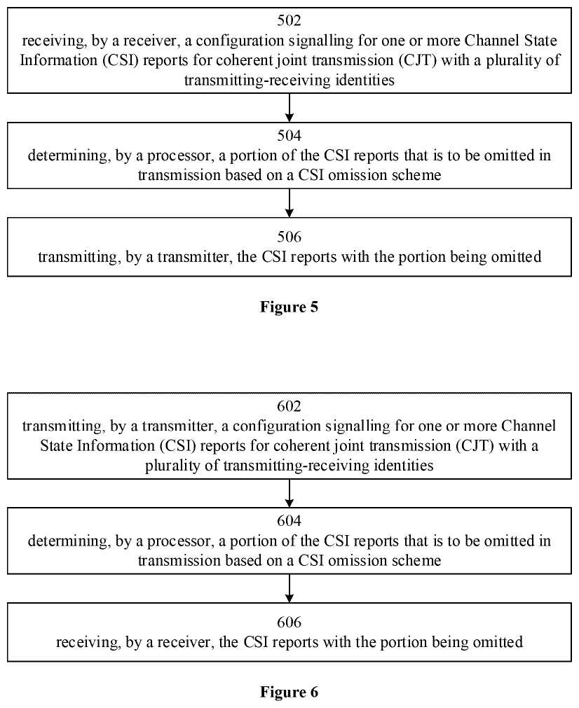

FIG. 6 is a flow chart illustrating steps of CSI omission for coherent joint transmission by gNB 300 in accordance with some implementations of the present disclosure.

At step 602, the transmitter 312 of gNB 300 transmits a configuration signalling for one or more Channel State Information (CSI) reports for coherent joint transmission (CJT) with a plurality of transmitting-receiving identities.

At step 604, the processor 302 of UE 300 determines a portion of the CSI reports that is to be omitted in transmission based on a CSI omission scheme.

At step 606, the receiver 314 of gNB 300 receives the CSI reports with the portion being omitted.

In one aspect, some items as examples of the disclosure concerning UE may be summarized as follows:

1. An apparatus, comprising:
a receiver that receives a configuration signalling for one or more Channel State Information (CSI) reports for coherent joint transmission (CJT) with a plurality of transmitting-receiving identities;
a processor that determines a portion of the CSI reports that is to be omitted in transmission based on a CSI omission scheme; and
a transmitter that transmits the CSI reports with the portion being omitted.

2. The apparatus of item 1, wherein the CSI omission scheme comprises a plurality of priority reporting levels for CSI bits on the transmitting-receiving identities; the portion of the CSI reports to be omitted is determined based on the priority reporting levels.

3. The apparatus of item 2, wherein the CSI bits on one priority reporting level comprise group 1 bits or group 2 bits of CSI report for one transmitting-receiving identity;

4. The apparatus of item 3, where the priority reporting levels are sorted as an ordered list of group 1 bits for each one of the transmitting-receiving identities, followed by an ordered list of group 2 bits for each one of the transmitting-receiving identities; or the priority reporting levels are sorted as an ordered list of group 1 bits and group 2 bits for a first one of the transmitting-receiving identities, followed by an ordered list of group 1 bits and group 2 bits for each subsequent one of the transmitting-receiving identities.

5. The apparatus of item 2, wherein the CSI bits on priority reporting level 0 comprise group 0 bits from all CSI reports for transmission; and the priority reporting level 0 includes group 0 bits for all transmitting-receiving identities that are cooperative for CJT; and the transmitting-receiving identities cooperative for CJT are configured or UE selected.

6. The apparatus of item 2, the CSI bits on one priority reporting level comprise group 1 bits and/or group 2 bits of CSI report for one transmitting-receiving identity; wherein co-phasing and/or co-amplitude bits are included in group 1 bits or group 2 bits.

7. The apparatus of item 2, wherein the CSI bits on one priority reporting level comprise group 3 bits; the priority reporting levels comprise additional levels defined for group 3 bits following group 2 bits; and co-phasing and/or co-amplitude bits are included in group 3 bits.

8. The apparatus of item 1, wherein the CSI omission scheme comprises a plurality of omission units in one priority reporting level, each omission unit comprising CSI bits corresponding to one of the transmitting-receiving identities; and CSI omission is made based on omission unit based on priority between omission units.

9. The apparatus of item 1, wherein the CSI omission scheme comprises a plurality of priority reporting levels for CSI bits; the portion of the CSI reports to be omitted is determined based on priority reporting levels with higher priority for group 1 bits and lower priority for group 2 bits; and the CSI bits in group 1 or group 2 include CSI bits from the plurality of transmitting-receiving identities, including: i_{1,7,l}, i_{2,4,l}, i_{2,5,l} with higher priority for group 1, i_{1,7,l}, i_{2,4,l}, i_{2,5,l} with lower priority for group 2.

10. The apparatus of item 9, wherein an enhanced bit priority is used for determining i_{1,7,l}, i_{2,4,l}, i_{2,5,l} bits from the plurality of transmitting-receiving identities in group 1 or group 2, where total number of non-zero coefficients for the plurality of transmitting-receiving identities is configured; or a legacy bit priority is used for determining i_{1,7,l}, i_{2,4,l}, i_{2,5,l} bits from the plurality of transmitting-receiving identities in group 1 or group 2, where separate number of non-zero coefficients for each of the transmitting-receiving identities is configured.

11. The apparatus of item 10, wherein the enhanced bit priority is defined as:

$$Pri ( l , i , f , n ) = 2 \cdot N \cdot L \cdot v \cdot π ( f ) + N \cdot v \cdot i + N \cdot ( l - 1 ) + n ;$$

where N is cooperative transmitting-receiving identity number for CJT; L is selected beam number for CJT; υ is layer number for CJT; M_{υ} is selected basis number for CJT; n denotes transmitting-receiving identity index; l denotes layer index; i denotes beam index, f denotes basis index in transform domain.

12. The apparatus of item 10, wherein the enhanced bit priority is defined as:

$$Pri ( l , i , f , n ) = 2 \cdot n \cdot L \cdot v \cdot {M}_{v} + 2 \cdot L \cdot v \cdot π ( f ) + v \cdot i + l ;$$

where N is cooperative transmitting-receiving identity number for CJT; L is selected beam number for CJT; υ is layer number for CJT; M_{υ} is selected basis number for CJT; n denotes transmitting-receiving identity index; l denotes layer index; i denotes beam index, f denotes basis index in transform domain.

13. The apparatus of item 10, wherein CSI bits in group 1 or group 2 with legacy bit priority are concatenated at first level on CSI fields, and at second level on transmitting-receiving identities from smaller ID to larger ID.

14. The apparatus of item 10, wherein CSI bits in group 1 or group 2 with legacy bit priority are concatenated at first level on transmitting-receiving identities from smaller ID to larger ID, and at second level on CSI fields.

15. The apparatus of item 9, wherein the CSI bits on priority reporting level 0 comprise group 0 bits from all CSI reports for transmission; and the priority reporting level 0 includes group 0 bits for all transmitting-receiving identities that are cooperative for CJT; and the transmitting-receiving identities cooperative for CJT are configured or UE selected; and/or
wherein the CSI bits on one priority reporting level comprise group 1 bits and/or group 2 bits of CSI report for one transmitting-receiving identity; wherein co-phasing and/or co-amplitude bits are included in group 1 bits or group 2 bits; or the CSI bits on one priority reporting level comprise group 3 bits; the priority reporting levels comprise additional levels defined for group 3 bits following group 2 bits; and co-phasing and/or co-amplitude bits are included in group 3 bits.

16. The apparatus of item 2, wherein the CSI omission scheme comprises omitting CSI bits from the priority reporting level for CJT and not omitting the next lower priority reporting level(s) if bits on lower priority reporting level(s) are capable of being carried by PUSCH.

17. The apparatus of item 1, wherein the CSI reports are configured with restriction that a CSI report with larger index (ID) is configured for CJT, and a CSI report with lower ID is configured for transmission with a single transmitting-receiving identity, or
that a CSI report with larger index (ID) is configured for higher order CJT, and a CSI report with lower ID is configured for lower order CJT.

18. The apparatus of item 1, wherein each of the transmitting-receiving identities is implicitly linked with a configured CSI-RS resource or a CSI-RS port group in one CSI-RS resource, each transmitting-receiving identity with an ID determined by configuration order of configured CSI-RS resource or CSI-RS port group index in one CSI-RS resource.

In another aspect, some items as examples of the disclosure concerning gNB may be summarized as follows:

19. An apparatus, comprising:
a transmitter that transmits a configuration signalling for one or more Channel State Information (CSI) reports for coherent joint transmission (CJT) with a plurality of transmitting-receiving identities;
a processor that determines a portion of the CSI reports that is to be omitted in transmission based on a CSI omission scheme; and
a receiver that receives the CSI reports with the portion being omitted.

20. The apparatus of item 19, wherein the CSI omission scheme comprises a plurality of priority reporting levels for CSI bits on the transmitting-receiving identities; the portion of the CSI reports to be omitted is determined based on the priority reporting levels.

21. The apparatus of item 20, wherein the CSI bits on one priority reporting level comprise group 1 bits or group 2 bits of CSI report for one transmitting-receiving identity;

22. The apparatus of item 21, where the priority reporting levels are sorted as an ordered list of group 1 bits for each one of the transmitting-receiving identities, followed by an ordered list of group 2 bits for each one of the transmitting-receiving identities; or the priority reporting levels are sorted as an ordered list of group 1 bits and group 2 bits for a first one of the transmitting-receiving identities, followed by an ordered list of group 1 bits and group 2 bits for each subsequent one of the transmitting-receiving identities.

23. The apparatus of item 20, wherein the CSI bits on priority reporting level 0 comprise group 0 bits from all CSI reports for transmission; and the priority reporting level 0 includes group 0 bits for all transmitting-receiving identities that are cooperative for CJT; and the transmitting-receiving identities cooperative for CJT are configured or UE selected.

24. The apparatus of item 20, the CSI bits on one priority reporting level comprise group 1 bits and/or group 2 bits of CSI report for one transmitting-receiving identity; wherein co-phasing and/or co-amplitude bits are included in group 1 bits or group 2 bits.

25. The apparatus of item 20, wherein the CSI bits on one priority reporting level comprise group 3 bits; the priority reporting levels comprise additional levels defined for group 3 bits following group 2 bits; and co-phasing and/or co-amplitude bits are included in group 3 bits.

26. The apparatus of item 19, wherein the CSI omission scheme comprises a plurality of omission units in one priority reporting level, each omission unit comprising CSI bits corresponding to one of the transmitting-receiving identities; and CSI omission is made based on omission unit based on priority between omission units.

27. The apparatus of item 19, wherein the CSI omission scheme comprises a plurality of priority reporting levels for CSI bits; the portion of the CSI reports to be omitted is determined based on priority reporting levels with higher priority for group 1 bits and lower priority for group 2 bits; and the CSI bits in group 1 or group 2 include CSI bits from the plurality of transmitting-receiving identities, including: i_{1,7,l}, i_{2,4,l}, i_{2,5,l} with higher priority for group 1, i_{1,7,l}, i_{2,4,l}, i_{2,5,l} with lower priority for group 2.

28. The apparatus of item 27, wherein an enhanced bit priority is used for determining i_{1,7,l}, i_{2,4,l}, i_{2,5,l} bits from the plurality of transmitting-receiving identities in group 1 or group 2, where total number of non-zero coefficients for the plurality of transmitting-receiving identities is configured; or a legacy bit priority is used for determining i_{1,7,l}, i_{2,4,l}, i_{2,5,l} bits from the plurality of transmitting-receiving identities in group 1 or group 2, where separate number of non-zero coefficients for each of the transmitting-receiving identities is configured.

29. The apparatus of item 28, wherein the enhanced bit priority is defined as:

$$Pri ( l , i , f , n ) = 2 \cdot N \cdot L \cdot v \cdot π ( f ) + N \cdot v \cdot i + N \cdot ( l - 1 ) + n ;$$

where N is cooperative transmitting-receiving identity number for CJT; L is selected beam number for CJT; υ is layer number for CJT; M_{υ} is selected basis number for CJT; n denotes transmitting-receiving identity index; l denotes layer index; i denotes beam index, f denotes basis index in transform domain.

30. The apparatus of item 28, wherein the enhanced bit priority is defined as:

$$Pri ( l , i , f , n ) = 2 \cdot n \cdot L \cdot v \cdot {M}_{v} + 2 \cdot L \cdot v \cdot π ( f ) + v \cdot i + l ;$$

where N is cooperative transmitting-receiving identity number for CJT; L is selected beam number for CJT; υ is layer number for CJT; M_{υ} is selected basis number for CJT; n denotes transmitting-receiving identity index; l denotes layer index; i denotes beam index, f denotes basis index in transform domain.

31. The apparatus of item 28, wherein CSI bits in group 1 or group 2 with legacy bit priority are concatenated at first level on CSI fields, and at second level on transmitting-receiving identities from smaller ID to larger ID.

32. The apparatus of item 28, wherein CSI bits in group 1 or group 2 with legacy bit priority are concatenated at first level on transmitting-receiving identities from smaller ID to larger ID, and at second level on CSI fields.

33. The apparatus of item 27, wherein the CSI bits on priority reporting level 0 comprise group 0 bits from all CSI reports for transmission; and the priority reporting level 0 includes group 0 bits for all transmitting-receiving identities that are cooperative for CJT; and the transmitting-receiving identities cooperative for CJT are configured or UE selected; and/or
wherein the CSI bits on one priority reporting level comprise group 1 bits and/or group 2 bits of CSI report for one transmitting-receiving identity; wherein co-phasing and/or co-amplitude bits are included in group 1 bits or group 2 bits; or the CSI bits on one priority reporting level comprise group 3 bits; the priority reporting levels comprise additional levels defined for group 3 bits following group 2 bits; and co-phasing and/or co-amplitude bits are included in group 3 bits.

34. The apparatus of item 20, wherein the CSI omission scheme comprises omitting CSI bits from the priority reporting level for CJT and not omitting the next lower priority reporting level(s) if bits on lower priority reporting level(s) are capable of being carried by PUSCH.

35. The apparatus of item 19, wherein the CSI reports are configured with restriction that a CSI report with larger index (ID) is configured for CJT, and a CSI report with lower ID is configured for transmission with a single transmitting-receiving identity, or
that a CSI report with larger index (ID) is configured for higher order CJT, and a CSI report with lower ID is configured for lower order CJT.

36. The apparatus of item 19, wherein each of the transmitting-receiving identities is implicitly linked with a configured CSI-RS resource or a CSI-RS port group in one CSI-RS resource, each transmitting-receiving identity with an ID determined by configuration order of configured CSI-RS resource or CSI-RS port group index in one CSI-RS resource.

In a further aspect, some items as examples of the disclosure concerning a method of UE may be summarized as follows:

37. A method, comprising:
receiving, by a receiver, a configuration signalling for one or more Channel State Information (CSI) reports for coherent joint transmission (CJT) with a plurality of transmitting-receiving identities;
determining, by a processor, a portion of the CSI reports that is to be omitted in transmission based on a CSI omission scheme; and
transmitting, by a transmitter, the CSI reports with the portion being omitted.

38. The method of item 37, wherein the CSI omission scheme comprises a plurality of priority reporting levels for CSI bits on the transmitting-receiving identities; the portion of the CSI reports to be omitted is determined based on the priority reporting levels.

39. The method of item 38, wherein the CSI bits on one priority reporting level comprise group 1 bits or group 2 bits of CSI report for one transmitting-receiving identity;

40. The method of item 39, where the priority reporting levels are sorted as an ordered list of group 1 bits for each one of the transmitting-receiving identities, followed by an ordered list of group 2 bits for each one of the transmitting-receiving identities; or the priority reporting levels are sorted as an ordered list of group 1 bits and group 2 bits for a first one of the transmitting-receiving identities, followed by an ordered list of group 1 bits and group 2 bits for each subsequent one of the transmitting-receiving identities.

41. The method of item 38, wherein the CSI bits on priority reporting level 0 comprise group 0 bits from all CSI reports for transmission; and the priority reporting level 0 includes group 0 bits for all transmitting-receiving identities that are cooperative for CJT; and the transmitting-receiving identities cooperative for CJT are configured or UE selected.

42. The method of item 38, the CSI bits on one priority reporting level comprise group 1 bits and/or group 2 bits of CSI report for one transmitting-receiving identity; wherein co-phasing and/or co-amplitude bits are included in group 1 bits or group 2 bits.

43. The method of item 38, wherein the CSI bits on one priority reporting level comprise group 3 bits; the priority reporting levels comprise additional levels defined for group 3 bits following group 2 bits; and co-phasing and/or co-amplitude bits are included in group 3 bits.

44. The method of item 37, wherein the CSI omission scheme comprises a plurality of omission units in one priority reporting level, each omission unit comprising CSI bits corresponding to one of the transmitting-receiving identities; and CSI omission is made based on omission unit based on priority between omission units.

45. The method of item 37, wherein the CSI omission scheme comprises a plurality of priority reporting levels for CSI bits; the portion of the CSI reports to be omitted is determined based on priority reporting levels with higher priority for group 1 bits and lower priority for group 2 bits; and the CSI bits in group 1 or group 2 include CSI bits from the plurality of transmitting-receiving identities, including: i_{1,7,l}, i_{2,4,l}, i_{2,5,l} with higher priority for group 1, i_{1,7,l}, i_{2,4,l}, i_{2,5,l} with lower priority for group 2.

46. The method of item 45, wherein an enhanced bit priority is used for determining i_{1,7,l}, i_{2,4,l}, i_{2,5,l} bits from the plurality of transmitting-receiving identities in group 1 or group 2, where total number of non-zero coefficients for the plurality of transmitting-receiving identities is configured; or a legacy bit priority is used for determining i_{1,7,l}, i_{2,4,l}, i_{2,5,l} bits from the plurality of transmitting-receiving identities in group 1 or group 2, where separate number of non-zero coefficients for each of the transmitting-receiving identities is configured.

47. The method of item 46, wherein the enhanced bit priority is defined as:

$$Pri ( l , i , f , n ) = 2 \cdot N \cdot L \cdot v \cdot π ( f ) + N \cdot v \cdot i + N \cdot ( l - 1 ) + n ;$$

where N is cooperative transmitting-receiving identity number for CJT; L is selected beam number for CJT; υ is layer number for CJT; M_{υ} is selected basis number for CJT; n denotes transmitting-receiving identity index; l denotes layer index; i denotes beam index, f denotes basis index in transform domain.

48. The method of item 46, wherein the enhanced bit priority is defined as:

$$Pri ( l , i , f , n ) = 2 \cdot n \cdot L \cdot v \cdot {M}_{v} + 2 \cdot L \cdot v \cdot π ( f ) + v \cdot i + l ;$$

where N is cooperative transmitting-receiving identity number for CJT; L is selected beam number for CJT; υ is layer number for CJT; M_{υ} is selected basis number for CJT; n denotes transmitting-receiving identity index; l denotes layer index; i denotes beam index, f denotes basis index in transform domain.

49. The method of item 46, wherein CSI bits in group 1 or group 2 with legacy bit priority are concatenated at first level on CSI fields, and at second level on transmitting-receiving identities from smaller ID to larger ID.

50. The method of item 46, wherein CSI bits in group 1 or group 2 with legacy bit priority are concatenated at first level on transmitting-receiving identities from smaller ID to larger ID, and at second level on CSI fields.

51. The method of item 45, wherein the CSI bits on priority reporting level 0 comprise group 0 bits from all CSI reports for transmission; and the priority reporting level 0 includes group 0 bits for all transmitting-receiving identities that are cooperative for CJT; and the transmitting-receiving identities cooperative for CJT are configured or UE selected; and/or
wherein the CSI bits on one priority reporting level comprise group 1 bits and/or group 2 bits of CSI report for one transmitting-receiving identity; wherein co-phasing and/or co-amplitude bits are included in group 1 bits or group 2 bits; or the CSI bits on one priority reporting level comprise group 3 bits; the priority reporting levels comprise additional levels defined for group 3 bits following group 2 bits; and co-phasing and/or co-amplitude bits are included in group 3 bits.

52. The method of item 38, wherein the CSI omission scheme comprises omitting CSI bits from the priority reporting level for CJT and not omitting the next lower priority reporting level(s) if bits on lower priority reporting level(s) are capable of being carried by PUSCH.

53. The method of item 37, wherein the CSI reports are configured with restriction that a CSI report with larger index (ID) is configured for CJT, and a CSI report with lower ID is configured for transmission with a single transmitting-receiving identity, or
that a CSI report with larger index (ID) is configured for higher order CJT, and a CSI report with lower ID is configured for lower order CJT.

54. The method of item 37, wherein each of the transmitting-receiving identities is implicitly linked with a configured CSI-RS resource or a CSI-RS port group in one CSI-RS resource, each transmitting-receiving identity with an ID determined by configuration order of configured CSI-RS resource or CSI-RS port group index in one CSI-RS resource.

In a yet further aspect, some items as examples of the disclosure concerning a method of gNB may be summarized as follows:

55. A method, comprising:
transmitting, by a transmitter, a configuration signalling for one or more Channel State Information (CSI) reports for coherent joint transmission (CJT) with a plurality of transmitting-receiving identities;
determining, by a processor, a portion of the CSI reports that is to be omitted in transmission based on a CSI omission scheme; and
receiving, by a receiver, the CSI reports with the portion being omitted.

56. The method of item 55, wherein the CSI omission scheme comprises a plurality of priority reporting levels for CSI bits on the transmitting-receiving identities; the portion of the CSI reports to be omitted is determined based on the priority reporting levels.

57. The method of item 56, wherein the CSI bits on one priority reporting level comprise group 1 bits or group 2 bits of CSI report for one transmitting-receiving identity;

58. The method of item 57, where the priority reporting levels are sorted as an ordered list of group 1 bits for each one of the transmitting-receiving identities, followed by an ordered list of group 2 bits for each one of the transmitting-receiving identities; or the priority reporting levels are sorted as an ordered list of group 1 bits and group 2 bits for a first one of the transmitting-receiving identities, followed by an ordered list of group 1 bits and group 2 bits for each subsequent one of the transmitting-receiving identities.

59. The method of item 56, wherein the CSI bits on priority reporting level 0 comprise group 0 bits from all CSI reports for transmission; and the priority reporting level 0 includes group 0 bits for all transmitting-receiving identities that are cooperative for CJT; and the transmitting-receiving identities cooperative for CJT are configured or UE selected.

60. The method of item 56, the CSI bits on one priority reporting level comprise group 1 bits and/or group 2 bits of CSI report for one transmitting-receiving identity; wherein co-phasing and/or co-amplitude bits are included in group 1 bits or group 2 bits.

61. The method of item 56, wherein the CSI bits on one priority reporting level comprise group 3 bits; the priority reporting levels comprise additional levels defined for group 3 bits following group 2 bits; and co-phasing and/or co-amplitude bits are included in group 3 bits.

62. The method of item 55, wherein the CSI omission scheme comprises a plurality of omission units in one priority reporting level, each omission unit comprising CSI bits corresponding to one of the transmitting-receiving identities; and CSI omission is made based on omission unit based on priority between omission units.

63. The method of item 55, wherein the CSI omission scheme comprises a plurality of priority reporting levels for CSI bits; the portion of the CSI reports to be omitted is determined based on priority reporting levels with higher priority for group 1 bits and lower priority for group 2 bits; and the CSI bits in group 1 or group 2 include CSI bits from the plurality of transmitting-receiving identities, including: i_{1,7,l}, i_{2,4,l}, i_{2,5,l} with higher priority for group 1, i_{1,7,l}, i_{2,4,l}, i_{2,5,l} with lower priority for group 2.

64. The method of item 63, wherein an enhanced bit priority is used for determining i_{1,7,l}, i_{2,4,l}, i_{2,5,l} bits from the plurality of transmitting-receiving identities in group 1 or group 2, where total number of non-zero coefficients for the plurality of transmitting-receiving identities is configured; or a legacy bit priority is used for determining i_{1,7,l}, i_{2,4,l}, i_{2,5,l} bits from the plurality of transmitting-receiving identities in group 1 or group 2, where separate number of non-zero coefficients for each of the transmitting-receiving identities is configured.

65. The method of item 64, wherein the enhanced bit priority is defined as:

$$Pri ( l , i , f , n ) = 2 \cdot N \cdot L \cdot v \cdot π ( f ) + N \cdot v \cdot i + N \cdot ( l - 1 ) + n ;$$

where N is cooperative transmitting-receiving identity number for CJT; L is selected beam number for CJT; υ is layer number for CJT; M_{υ} is selected basis number for CJT; n denotes transmitting-receiving identity index; l denotes layer index; i denotes beam index, f denotes basis index in transform domain.

66. The method of item 64, wherein the enhanced bit priority is defined as:

$$Pri ( l , i , f , n ) = 2 \cdot n \cdot L \cdot v \cdot {M}_{v} + 2 \cdot L \cdot v \cdot π ( f ) + v \cdot i + l ;$$

where N is cooperative transmitting-receiving identity number for CJT; L is selected beam number for CJT; υ is layer number for CJT; M_{υ} is selected basis number for CJT; n denotes transmitting-receiving identity index; l denotes layer index; i denotes beam index, f denotes basis index in transform domain.

67. The method of item 64, wherein CSI bits in group 1 or group 2 with legacy bit priority are concatenated at first level on CSI fields, and at second level on transmitting-receiving identities from smaller ID to larger ID.

68. The method of item 64, wherein CSI bits in group 1 or group 2 with legacy bit priority are concatenated at first level on transmitting-receiving identities from smaller ID to larger ID, and at second level on CSI fields.

69. The method of item 63, wherein the CSI bits on priority reporting level 0 comprise group 0 bits from all CSI reports for transmission; and the priority reporting level 0 includes group 0 bits for all transmitting-receiving identities that are cooperative for CJT; and the transmitting-receiving identities cooperative for CJT are configured or UE selected; and/or
wherein the CSI bits on one priority reporting level comprise group 1 bits and/or group 2 bits of CSI report for one transmitting-receiving identity; wherein co-phasing and/or co-amplitude bits are included in group 1 bits or group 2 bits; or the CSI bits on one priority reporting level comprise group 3 bits; the priority reporting levels comprise additional levels defined for group 3 bits following group 2 bits; and co-phasing and/or co-amplitude bits are included in group 3 bits.

70. The method of item 56, wherein the CSI omission scheme comprises omitting CSI bits from the priority reporting level for CJT and not omitting the next lower priority reporting level(s) if bits on lower priority reporting level(s) are capable of being carried by PUSCH.

71. The method of item 55, wherein the CSI reports are configured with restriction that a CSI report with larger index (ID) is configured for CJT, and a CSI report with lower ID is configured for transmission with a single transmitting-receiving identity, or
that a CSI report with larger index (ID) is configured for higher order CJT, and a CSI report with lower ID is configured for lower order CJT.

72. The method of item 55, wherein each of the transmitting-receiving identities is implicitly linked with a configured CSI-RS resource or a CSI-RS port group in one CSI-RS resource, each transmitting-receiving identity with an ID determined by configuration order of configured CSI-RS resource or CSI-RS port group index in one CSI-RS resource.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. An apparatus for wireless communication, comprising:
at least one memory, and
at least one processor coupled with the at least one memory and configured to cause the apparatus to:
receive a configuration signaling for one or more Channel State Information (CSI) reports for coherent joint transmission (CJT) with a plurality of transmitting-receiving identities;
determine a portion of the CSI reports that is to be omitted in transmission based on a CSI omission scheme; and
transmit the CSI reports with the portion being omitted.

2. The apparatus of claim 1, wherein the CSI omission scheme comprises a plurality of priority reporting levels for CSI bits on the transmitting-receiving identities; the portion of the CSI reports to be omitted being determined based on the priority reporting levels.

3. The apparatus of claim 2, wherein the CSI bits on one priority reporting level comprise group 1 bits or group 2 bits of a CSI report for one transmitting-receiving identity;

4. The apparatus of claim 3, wherein the priority reporting levels are sorted as an ordered list of group 1 bits for each one of the transmitting-receiving identities, followed by an ordered list of group 2 bits for each one of the transmitting-receiving identities; or wherein the priority reporting levels are sorted as an ordered list of group 1 bits and group 2 bits for a first one of the transmitting-receiving identities, followed by an ordered list of group 1 bits and group 2 bits for each subsequent one of the transmitting-receiving identities.

5. The apparatus of claim 2, wherein the CSI bits on priority reporting level 0 comprise group 0 bits from all CSI reports for transmission; and the priority reporting level 0 includes group 0 bits for all transmitting-receiving identities that are cooperative for CJT; and the transmitting-receiving identities cooperative for CJT are configured or UE selected.

6. The apparatus of claim 2, wherein the CSI bits on one priority reporting level comprise group 1 bits or group 2 bits of CSI report for one transmitting-receiving identity; wherein co-phasing or co-amplitude bits are included in group 1 bits or group 2 bits; or
wherein the CSI bits on one priority reporting level comprise group 3 bits; the priority reporting levels comprise additional levels defined for group 3 bits following group 2 bits; and co-phasing or co-amplitude bits are included in group 3 bits.

7. The apparatus of claim 1, wherein the CSI omission scheme comprises a plurality of priority reporting levels for CSI bits; the portion of the CSI reports to be omitted is determined based on priority reporting levels with higher priority for group 1 bits and lower priority for group 2 bits; and the CSI bits in group 1 or group 2 include CSI bits from the plurality of transmitting-receiving identities, including: i_{1,7,l}, i_{2,4,l}, i_{2,5,l} with higher priority for group 1, i_{1,7,l}, i_{2,4,l}, i_{2,5,l} with lower priority for group 2.

8. The apparatus of claim 7, wherein an enhanced bit priority is used for determining i_{1,7,l}, i_{2,4,l}, i_{2,5,l} bits from the plurality of transmitting-receiving identities in group 1 or group 2, where total number of non-zero coefficients for the plurality of transmitting-receiving identities is determined by configured parameters.

9. The apparatus of claim 8, wherein the enhanced bit priority is defined as:
$$Pri ( l , i , f , n ) = 2 \cdot N \cdot L \cdot v \cdot π ( f ) + N \cdot v \cdot i + N \cdot ( l - 1 ) + n ; or$$
$$Pri ( l , i , f , n ) = 2 \cdot n \cdot L \cdot v \cdot {M}_{v} + 2 \cdot L \cdot v \cdot π ( f ) + v \cdot i + l ;$$
where N is cooperative transmitting-receiving identity number for CJT; L is selected beam number for CJT; υ is layer number for CJT; M_{υ} is selected basis number for CJT; n denotes transmitting-receiving identity index; l denotes layer index; i denotes beam index, f denotes basis index in transform domain.

10. The apparatus of claim 8, wherein CSI bits in group 1 or group 2 with legacy bit priority are concatenated at first level on CSI fields, and at second level on transmitting-receiving identities from smaller ID to larger ID; or
wherein CSI bits in group 1 or group 2 with legacy bit priority are concatenated at first level on transmitting-receiving identities from smaller ID to larger ID, and at second level on CSI fields.

11. The apparatus of claim 7, wherein the CSI bits on priority reporting level 0 comprise group 0 bits from all CSI reports for transmission; and the priority reporting level 0 includes group 0 bits for all transmitting-receiving identities that are cooperative for CJT; and the transmitting-receiving identities cooperative for CJT are configured or UE selected.

12. The apparatus of claim 1, wherein the CSI reports are configured with a restriction that a CSI report with larger index (ID) is configured for CJT, and a CSI report with lower ID is configured for transmission with a single transmitting-receiving identity, or
that a CSI report with larger index (ID) is configured for higher order CJT, and a CSI report with lower ID is configured for lower order CJT.

13. The apparatus of claim 1, wherein each of the transmitting-receiving identities is implicitly linked with a configured CSI-RS resource or a CSI-RS port group in one CSI-RS resource, each transmitting-receiving identity with an ID determined by configuration order of configured CSI-RS resource or CSI-RS port group index in one CSI-RS resource.

14. An apparatus for wireless communication, comprising:
at least one memory, and
at least one processor coupled with the at least one memory and configured to cause the apparatus to:
transmit a configuration signaling for one or more Channel State Information (CSI) reports for coherent joint transmission (CJT) with a plurality of transmitting-receiving identities;
determine a portion of the CSI reports that is to be omitted in transmission based on a CSI omission scheme; and
receive the CSI reports with the portion being omitted.

15. A method, comprising:
receiving a configuration signaling for one or more Channel State Information (CSI) reports for coherent joint transmission (CJT) with a plurality of transmitting-receiving identities;
determining a portion of the CSI reports that is to be omitted in transmission based on a CSI omission scheme; and
transmitting the CSI reports with the portion being omitted.

16. A processor for wireless communication, comprising:
at least one controller coupled with at least one memory and configured to cause the processor to:
receive a configuration signaling for one or more Channel State Information (CSI) reports for coherent joint transmission (CJT) with a plurality of transmitting-receiving identities;
determine a portion of the CSI reports that is to be omitted in transmission based on a CSI omission scheme; and
transmit the CSI reports with the portion being omitted.

17. The processor of claim 16, wherein the CSI omission scheme comprises a plurality of priority reporting levels for CSI bits on the transmitting-receiving identities; the portion of the CSI reports to be omitted being determined based on the priority reporting levels.

18. The processor of claim 16, wherein the CSI omission scheme comprises a plurality of priority reporting levels for CSI bits; the portion of the CSI reports to be omitted is determined based on priority reporting levels with higher priority for group 1 bits and lower priority for group 2 bits; and the CSI bits in group 1 or group 2 include CSI bits from the plurality of transmitting-receiving identities, including: i_{1,7,l}, i_{2,4,l}, i_{2,5,l} with higher priority for group 1, i_{1,7,l}, i_{2,4,l}, i_{2,5,l} with lower priority for group 2.

19. The processor of claim 18, wherein an enhanced bit priority is used for determining i_{1,7,l}, i_{2,4,l}, i_{2,5,l} bits from the plurality of transmitting-receiving identities in group 1 or group 2, where total number of non-zero coefficients for the plurality of transmitting-receiving identities is configured.

20. The processor of claim 18, wherein the CSI bits on priority reporting level 0 comprise group 0 bits from all CSI reports for transmission; and the priority reporting level 0 includes group 0 bits for all transmitting-receiving identities that are cooperative for CJT; and the transmitting-receiving identities cooperative for CJT are configured or UE selected.
